(19) United States
(12) Patent Application Publication
(10) Pub. No.: US 2008/0304677 A1
(43) Pub. Date: Dec. 11, 2008

(54) SYSTEM AND METHOD FOR NOISE CANCELLATION WITH MOTION TRACKING CAPABILITY

(75) Inventors: Amir ABOLFATHI, Woodside, CA (US); Mohsen Sarraf, Rumson, NJ (US)

Correspondence Address: LEVINE BAGADE HAN LLP, 2483 EAST BAYSHORE ROAD, SUITE 100, PALO ALTO, CA, 94303, US

(73) Assignee: Sonitus Medical Inc., Menlo Park, CA (US)

(21) Appl. No.: 11/761,891

(22) Filed: Jun. 12, 2007

Related U.S. Application Data
(60) Provisional application No. 60/942,943, filed on Jun. 8, 2007.

(51) Int. Cl. G10K 11/178; G10K 11/00

(52) U.S. Cl. 381/71.1

(57) ABSTRACT

A system and method for noise cancellation is disclosed herein generally having at least one microphone, a processor, and a speaker array. The processor may contain an adaptive filtering feature, to separate desirable sound from undesirable sound. The undesirable sound may be suppressed by the processor by creating a canceling waveform and transmitting the canceling waveform to the user's head via a speaker array. The desirable sound may be enhanced by increasing the amplitude of the waveform and transmitting the amplified waveform to the user's head via a speaker array. The sound transmitted to the user's head by the system may be localized using an image tracking subsystem and speaker array. The image tracking system may track the actual visible image or alternatively a heat (e.g. infrared) image of the user's head.

### CROSS-REFERENCE TO RELATED APPLICATIONS

This application claims the benefit of priority to U.S. Provisional Patent Application Ser. No. 60/942,943 filed Jun. 8, 2007 which is incorporated herein by reference in its entirety.

### BACKGROUND OF THE INVENTION

Undesirable sounds and noises from various sources such as snoring of a partner or humming of an air conditioner, etc. can be annoying at times when silence is desired, (such as during sleep, studying, etc.). Acoustic Echo Cancellation (AEC) is a technology that can mitigate such undesired sounds by a great magnitude. Products such as noise canceling headphones have been in the market for many years and the technology has even been used in fighter aircraft to mitigate the engine noise while the pilot is communication. Cell phones and many high-end speakerphones also use the AEC technology as well.

AEC techniques are very efficient in suppressing unwanted sounds usually targeted at a point, or rather a very small space around a listener's ears or a microphone. for instance, noise-canceling headphones that are worn on the head of a user. These headphones can easily cancel the unwanted sounds at the users' ears. In some instances the user may not like to use a headphone to achieve the benefits of AEC technology, either due to comfort or practicality, such as during sleep. This invention addresses the latter case.

### BRIEF SUMMARY OF THE INVENTION

In order to relieve a user from wearing a headphone or a similar device, a system and method for noise cancellation may be provided generally comprising, in one variation, a microphone for detecting sound, a processor for receiving the sound, generating a canceling waveform with respect to the detected sound, and transmitting the canceling waveform in the direction of a user's head via a speaker array. In one variation, the processor may contain a filtering subsystem, such as adaptive acoustic echo cancellation (AEC) subsystem. The AEC subsystem may separate desirable sounds from undesirable sounds, e.g., undesirable sounds which the user would find disruptive such as snoring, that are detected by the microphone. Speaker arrays can provide directionality to the sounds they produce, therefore noise canceling sounds may be localized by the speaker array (produced by the AEC block) around the user's head. This may be achieved by running localization algorithms to the sound signal provided to the speaker elements of the speaker array to achieve the maximum sound effect in a particular direction. The sound intensity can also be adjusted by a similar adaptive signal processing subsystem.

The system may contain one or more microphones which may be placed in close proximity to the user's head to provide an accurate sample of the sound amplitude perceived by the user. In one variation, at least one microphone may be used to detect a first desirable and undesirable sound and at least one other microphone in a different location may be used to detect a second version of the same desirable and undesirable sound. In another variation, the AEC subsystem may suppress the undesirable sound by generating a canceling waveform for transmission by the speaker array. The desirable sounds, such as alarms, sirens and cries, may be sampled by a processor and their signature stored in a memory unit. The AEC system may include a separate subsystem that checks for the signature of these types of sounds and if there is no match, allows the AEC subsystem to suppress it otherwise it will enhance it or at the very least not suppress it. In one variation, the AEC subsystem may enhance the desirable sound by generating an amplified waveform to the speaker array.

The speaker array may comprise of two or more speakers which have the capability to direct signals toward a given direction. In one variation, the speakers may be mounted on a controllably movable device, such as a gimbal, to allow the speakers to be adjusted such that they point toward the user's head. In the event the user moves his or her head out of range of the AEC speaker array performance, the system may further comprise an image tracking system which contains an image tracking device (e.g. a camera) which may be used to track the location of the user's head as he or she moves. When engaged, the image tracking system may actively track the user's head while transmitting the coordinates of the location of the user's head to a processor which may control the direction of the speaker array such that they actively point in the direction of the user's head. With the user's head location known and tracked, the canceling waveform may be transmitted to the head in the vicinity of the user's ears to thus actively cancel the undesired sounds prior to reaching the ears of the user. The cancelled undesirable sound results in silence or a mitigated amplitude perceived by the user regardless of the physical movement of the user.

### BRIEF DESCRIPTION OF THE DRAWINGS

FIG. 1 schematically illustrates the phenomenon of destructive interference.

FIG. 2 illustrates an example for using a noise reduction system.

FIG. 3 schematically illustrates an example for using an acoustic echo cancellation system.

FIG. 4 illustrates an example for using an acoustic echo cancellation system to cancel the sound associated with, e.g., snoring or other undesirable noises from a partner.

FIG. 5 illustrates an example for using an acoustic echo cancellation system with a motion tracking camera to cancel the sound associated with, e.g., snoring.

FIG. 6 schematically illustrates an example for using an acoustic echo cancellation system with a motion tracking mechanism.

FIG. 7 illustrates a speaker array adjusted to localize sound toward a user based on motion detected by the tracking mechanism.

### DETAILED DESCRIPTION OF THE INVENTION

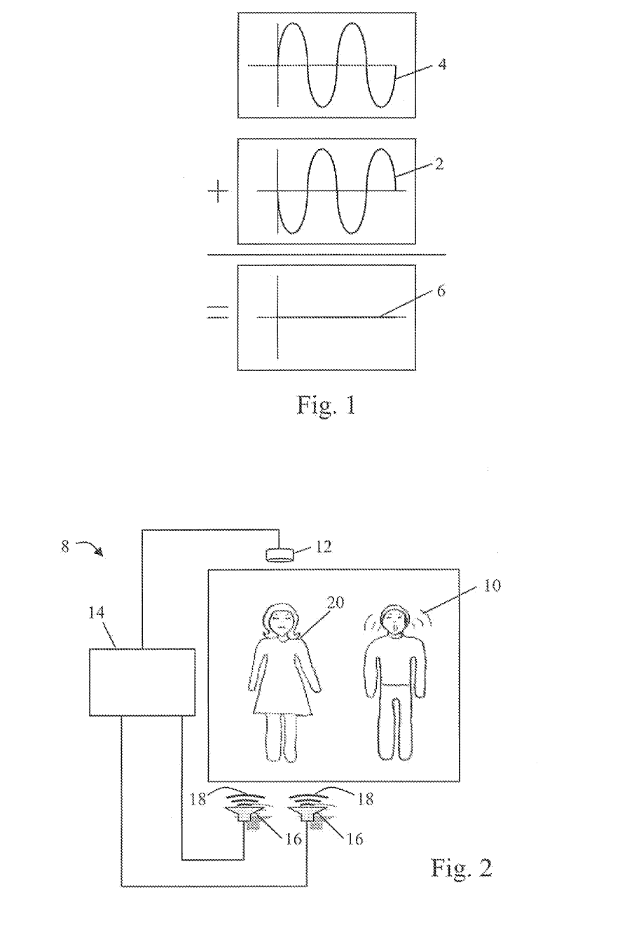

Sound is transmitted as a pressure wave which consists of a compression phase and a decompression or rarefaction phase. When two sound waves pass through the same region of space at the same time, a phenomenon known as interference occurs. As shown in FIG. 1, if the two waves are opposite one another as they pass by, the result is called destructive interference or phase cancellation. For example, if a speaker emits a sound wave 2 with the same amplitude but 180° out-of-phase (or opposite polarity) with respect to an original sound wave 4, the waves combine to form a new wave 6 which effectively cancels each other out, potentially resulting in no sound or a sound wave that may be so faint as to be inaudible to human ears. Using the concept of destructive interference, a system 8 may be provided to receive an undesirable sound 10 (e.g. snoring, humming of electronics, traffic, etc.) via a microphone 12, analyze the waveform of the undesired sound via a processor 14, and generate a modified waveform 18 for transmission via an array of speakers 16 to cancel out the undesired sound 10.

As shown in FIG. 2, an example is illustrated of a user 20 sleeping or lying next to or in proximity to a partner. At least one microphone 12 may be positioned in close proximity to the use 20 to receive an undesirable sound 10, such as snoring emitted by the partner. FIG. 2 illustrates placement of the microphone 12 behind the user's head, although the microphone 12 may be place anywhere near the user's head 20, such as next to the user's ear. The undesirable sound 10 that is detected by the microphone 12 may be transmitted to a processor 14 via a wired or wireless connection. The processor 14 or computer may analyze the waveform of the undesired sound signal 10 and generate a canceling waveform 18 (anti-phase) with respect to the undesirable sound signal 10. The canceling waveform 18 may thus be transmitted to the speaker array 16, which may be arranged such that the canceling waveform 18 is transmitted by the speakers 16 in the direction of the user's head and/or ears, canceling or reducing the undesired sound 10.

In another variation, a speaker array 16 in conjunction with a processor 22 containing a filtering feature such as acoustic echo cancellation (AEC) 24 may be utilized to eliminate or mitigate undesired sounds 10 received by the microphone 12. AEC algorithms are well utilized and are typically used to anticipate the signal which may re-enter the transmission path from the microphone 12 and cancel it out by digitally sampling an initial received signal to form a reference signal. Examples of acoustic echo cancellation are disclosed in U.S. Pat. Nos. 5,546,459; 5,661,813; and 7,003,099, the contents of which are incorporated herein by reference.

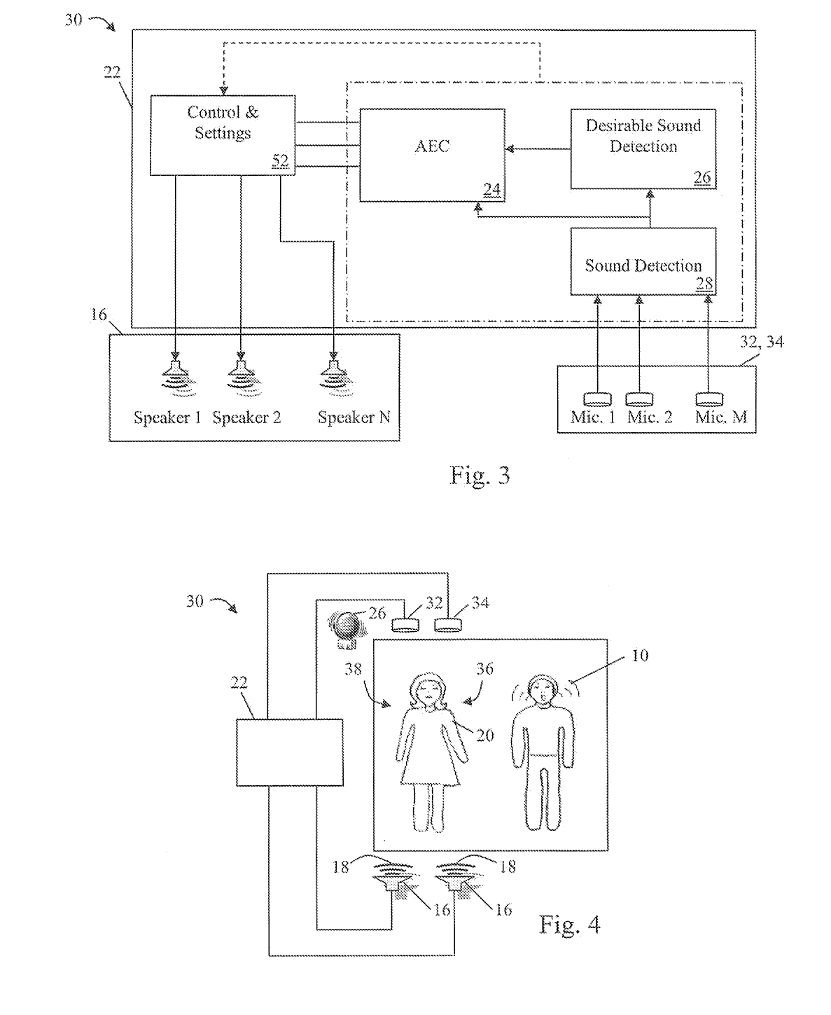

In the variation shown in FIGS. 3-4, a filtering system 30 may utilize one or more microphones 12 to detect sound 28 and to separate out desired sounds 26 (e.g., sirens, alarms, human cries, etc.) from undesirable sounds 10 (e.g., sounds resulting from snoring, humming of electronics, traffic, echo, etc.). Samples of the undesired sound signals 10 may be transmitted to a processor 22 and compared against the desired sound signals 26 by the AEC subsystem 24 to eliminate or mitigate the undesired sound signals 10 prior to generating the canceling waveform 18. This may result in only the desired sounds 26 being perceived by the user 20. Additionally, the processor 22 may contain a controller and settings subsystem 52 to determine the correct amplitude or loudness of the waveform 18 which in turn depends on the amplitude or loudness of the unwanted sound 10. The processor 22 may also be set to enhance desired sounds 26, such as alarms, versus merely allowing them to pass through to the user 20. Note that in FIG. 3, M is the number of microphones 12 in the system (e.g. one or more), and N is the number of speakers in the speaker array (e.g. two or more).

In the example shown in FIG. 4, a source of an undesirable sound 10 may be found on a first side 36 of the user 20. A first microphone 32 may be positioned along a first side 36 of the user 20 to receive undesired sounds 10 while a second microphone 34 may be positioned along a second side 38 of the user 20 to receive desirable sounds 26. Although it may be preferred to position the microphones 32, 34 in their respective positions to optimize detection of their respective undesirable 10 and desirable sounds 26, they may of course be positioned at other locations within close proximity to the user 20 as so desired or practicable. Moreover, while it may also be preferred for first and second microphones 32, 34 to detect only their respective sounds, this is not required. However, having the microphones 32, 34 detect different versions of the combination of undesired and desired sounds 10, 26, respectively, may be desirable so as to effectively process these signals via the AEC processor 24.

The desired sound signals 26 may be transmitted via wired or wireless communication where the signal may be sampled and received by the AEC processor 22. A portion of the desired sound 26 may be transmitted to one or more speakers 16. The resulting echo from the speaker array 16, if any, may be detected by the second microphone 34 along with any other undesirable sound signals 10, as mentioned above. The undesired sound signals 10 detected by the second microphone 34 or the sampled signal received by AEC processor 22 may be processed and shifted out-of-phase, e.g., ideally 180° out-of-phase at each frequency, such that the summation of the two sound signals results in a cancellation of any echo and/or other undesired sounds 10.

The resulting summed sound signal may be redirected through an adaptive filter and re-summed to further clarify the sound signal until the desired sound signal is passed along to the speaker array 16 where the filtered sound signal 26, free or relatively free from the undesired sounds 10, may be transmitted to the user 20. Although two microphones 32, 34 are described in this example, an array of additional microphones may be utilized in close proximity to the user 20. Alternatively, one or more microphones may also be worn by the user 20, such as in an earring, necklace, etc. Furthermore, although two speakers 16 are illustrated, other variations may include more than two if so desired.

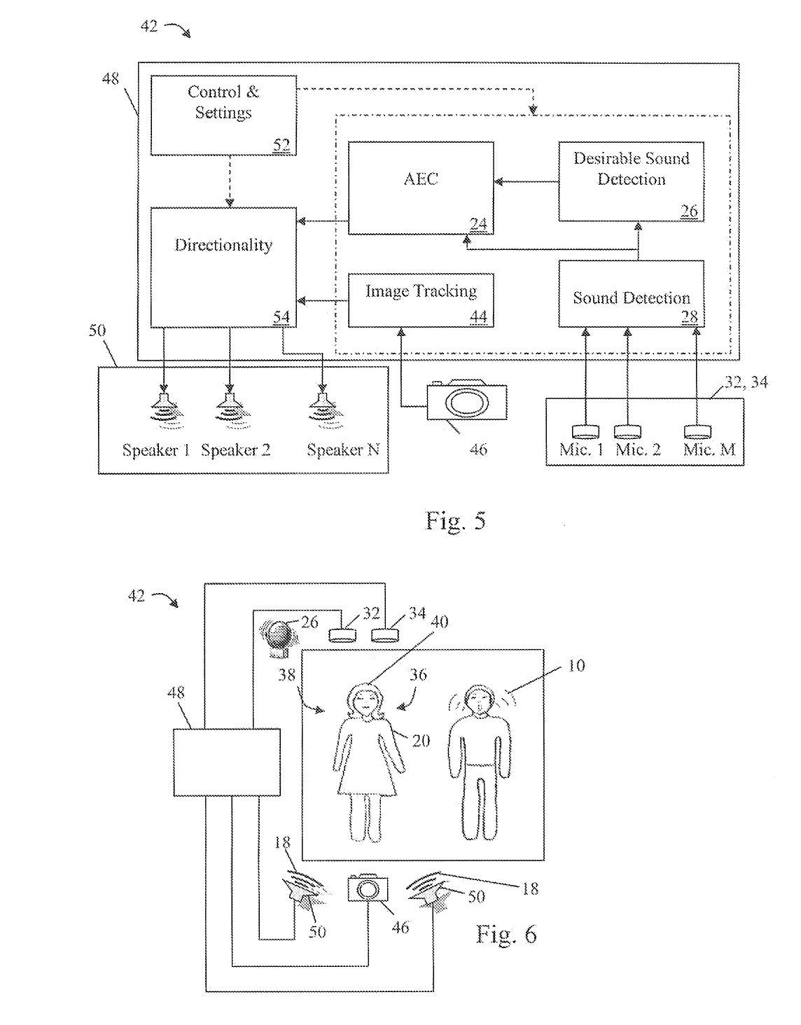

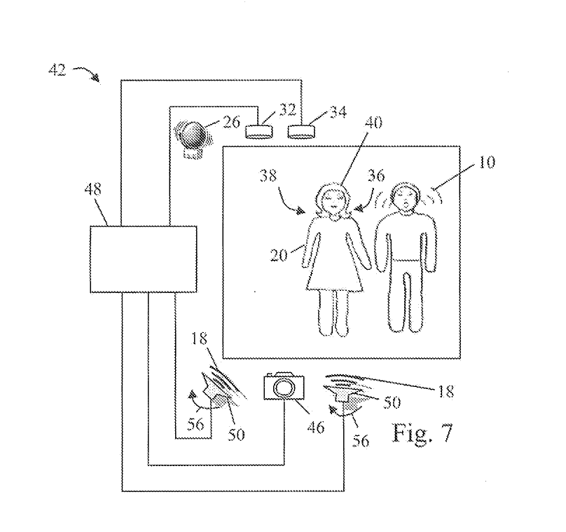

As the user 20 is likely to move his or her head 40 while asleep, the user 20 may potentially move out of the cone of performance of the speaker array 16 and thus reduce or lose the benefits that noise canceling provides. As a result, a noise canceling system 42 may also include an image tracking subsystem 44 with the capability to track the image of the head of the user 40 as he or she moves. As shown in FIGS. 5-7, the image of the head 40 may be received by an imaging device 46, such as a camera, which may further contain a mechanism for capturing an image in the dark, such as infrared, as is known in the art. The location of the head 40 may be transmitted by the camera 46 to a processor 48 where the image tracking subsystem 44 determines the appropriate arrangement of an adjustable speaker array 50 to localize the waveform 18 produced by the AEC subsystem 24 (as described above) in the direction of the user's head 40. The adjustable speaker array 50 may contain two or more speakers (N) mounted on a platform which allows the sound signal to be adjusted in any direction. As illustrated in FIG. 7, based on the appropriate arrangement of the speaker array determined by the image tracking subsystem 44, a directionality control 54 may rotate the effective direction of the sound signal produced by the speaker array (as shown by arrows 56), in the direction of the user's head 40 as the user 20 moves. Examples of image tracking systems are disclosed in U.S. Pat. Nos. 6,075,557 and 6,504,942, the contents of which are incorporated herein by reference.

Similar to high-end speakerphone systems, each time the system (8, 30, 42) is installed or moved from its installed location to another location, a self localization procedure is performed in order for the whole system to determine its location with respect to the environment the system is operating in. This information together with the camera's motion tracking information provides the processor (14, 22, 48) with the exact information required for direction adjustments.

The applications of the systems and methods may be applied to other areas of noise cancellation. While illustrative examples are described above, it will be apparent to one skilled in the art that various changes and modifications may be made therein. Moreover, various systems or methods described above are also intended to be utilized in combination with one another, as practicable. The appended claims are intended to cover all such changes and modifications that fall within the true spirit and scope of the invention.

What is claimed is:

1. A system for noise cancellation comprising:
at least one microphone for detecting sound;
a processor in electrical communication with the microphone, wherein the processor is configured to modify a waveform received by the at least one microphone in a manner to form a canceling waveform with respect to the received waveform; and
a speaker array having two or more speakers which are configured to transmit the canceling waveform generated by the processor in the direction of a user's head.

2. The system of claim 1 wherein the microphone is placed in proximity to the user's head.

3. The system of claim 1 further comprising a plurality of microphones.

4. The system of claim 3 wherein at least one microphone detects a first desired and undesired sound and at least one microphone detects a second version of the first desired and undesired sound.

5. The system of claim 1 wherein the processor comprises an adaptive acoustic echo cancellation subsystem.

6. The system of claim 5 wherein the adaptive acoustic echo cancellation subsystem is configured to filter undesired sound from desired sound.

7. The system of claim 6 wherein a sample of the desired sound is stored in the processor.

8. The system of claim 7 wherein the desired sound is selected from the group consisting of alarms, sirens, and cries.

9. The system of claim 6 wherein the processor generates a canceling waveform for the undesired sound.

10. The system of claim 6 wherein the desired sound is amplified by the processor.

11. The system of claim 1 further comprising of an image tracking device configured to track a location of the user's head.

12. The system of claim 11 wherein the image tracking device is a camera.

13. The system of claim 11 wherein the processor further comprises:
an image tracking subsystem to receive data from the image tracking device; and
a directionality control wherein the control rotates the speakers in the direction of the user's head based on the location data received by the image tracking subsystem.

14. The system of claim 13 wherein the speakers are mounted on a rotatable device.

15. The system of claim 14 wherein the rotatable device is a gimbal.

16. A method for noise cancellation comprising:
detecting sounds via at least one microphone;
generating a canceling waveform with respect to the detected sounds;
tracking a position of a user's head via an image tracking device; and
transmitting the out-of-phase waveform in a direction of the user's head via an adjustable speaker array.

17. The method of claim 16 further comprising filtering desired sound from undesired sound prior to transmitting the canceling waveform.

18. The method of claim 17 wherein filtering comprises filtering sound using adaptive acoustic echo cancellation.

19. The method of claim 17 further comprising amplifying the desired sound.

20. The method of claim 17 further comprising suppressing the undesired sound.

21. The method of claim 16 wherein tracking comprising actively tracking the user's head via a camera.

22. The method of claim 16 wherein transmitting comprises moving the effective field of the speaker array according to the position detected by the image tracking device of a location of the user's head.

23. The method of claim 16 wherein transmitting comprises transmitting the cancelling waveform via two or more adjustable speakers.
